(19) United States
(12) Patent Application Publication
(10) Pub. No.: US 2006/0155981 A1
(43) Pub. Date: Jul. 13, 2006

(54) Network device, network system and group management method

(75) Inventors: Mika Mizutani, Kawasaki (JP); Hideki Kamimaki, Kawasaki (JP); Akihiro Ebina, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MIZUTANAI Mika, KAMIMAKI Hideki, EBINA Akihiro, Chiyoda-ku, Tokyo (JP)

(21) Appl. No.: 10/540,768

(22) PCT Filed: Dec. 25, 2003
(86) PCT No.: PCT/JP03/16737

§ 371 Date: Dec. 16, 2005

(30) Foreign Application Priority Data
Dec. 25, 2002 (JP) 2002-375123

(51) Int. Cl. H04L 9/00

(52) U.S. Cl. 713/150

(57) ABSTRACT

A group is formed from appliances permitted by a user, to realize safe communication between appliances joining to the group. A group management processing unit 302 generates an encryption key used for cipher communication within the group, and stores the encryption key together with information required for cipher communication into its own storage unit and into a storage medium. An appliance that acquires the information required for cipher communication, by means of the storage medium, uses the information to send information on the appliance itself and the information required for cipher communication to the other appliances. When an appliance is to leave the group, the appliance deletes the information required for cipher communication, which the appliance itself holds, and notifies its leave to the other appliances, so that those appliances delete information on the leave appliance, which is held in those appliances.

### TECHNICAL FIELD

The present invention relates to a technique for exclusive and safe communication among specific appliances or devices connected to a network.

### BACKGROUND ART

An IP network using a communication protocol called Internet Protocol (hereinafter, referred to as IP) has established a position of a de facto standard for a computer network, and is now remarkably widespread among ordinary users.

To exchange data between devices through an IP network, each device should be given a unique IP address. At present, IPv4 (Internet Protocol version 4) that expresses an IP address with 32 bits is used. However, as use of an IP network expands, deficiency of IP addresses is becoming a large problem.

In this context, IETF (Internet Engineering Task Force) has adopted IPv6 (Internet Protocol version 6) for an IP network using a new IP address extended to 128 bits, with new added functions such as a security function non-existent in the past IP address. A network service using IPv6 is becoming a standard as a next generation IP.

Further, a home network is attracting attention as new application of IPv6 that provides the increased number of usable addresses and substantial security functions. A home network is a network comprising home appliances, for example, white goods such as a refrigerator and a washing machine and audiovisual equipment such as a television set and a video recorder.

By assigning an IP address to each of home appliances, each appliance can be considered as a server. Thus, it is considered to realize a new service using communication between appliances, or new services using Internet, such as control of appliances from an external terminal or a service center, for example.

Here, communication between specific devices such as home appliances requires a system that excludes operation from a device beyond the scope of recognition of users of the system. For example, it is necessary to prevent unrestricted operation by a device brought in by a user's friend.

In other words, a required system is one in which a user can determine a range of devices that can communicate with one another to form a group of these devices, and communication can only be held between devices joining or belonging to the group. To realize such communication, an authentication function is required so that devices in the group can authenticate one another as a true device belonging to the group.

The conventional client server system realizes such an authentication function using a certificate server. For example, in the case of RADIUS (Remote Authentication Dial-In User Service) defined by RFC2865, a certificate server called a RADIUS server manages the whole accounts (user names, passwords) of clients who make access to servers. A server transfers an access request (including a user name and a password) received from a client to the RADIUS server. Then, receiving a result of judgment on whether the access can be permitted, the server judges whether communication with the client should be started.

For example, as the conventional system and method of cipher communication between specific devices belonging to a group, those disclosed in Japanese Non-examined Patent Laid-open Nos. 2002-124941 (Patent Document 1) and 5-347616 (Patent Document 2) may be mentioned.

### DISCLOSURE OF THE INVENTION

In order that prescribed communication is held only between devices designated by a user among devices connected to a home network, it is considered that there should be a function of mutually authenticating a partner device as a device designated by the user.

The conventional authentication function assumes a client server system and is realized by providing a certificate server (authentication server) that manages access information of a client that makes access to a server.

In contrast, devices constituting a home network are of the ad hoc type in that communication is held between suitable devices required for a service. As a result, every device can become either a server or a client, and this causes a problem that setting of access information becomes more complicated.

In this case, if a certificate server is provided as in the conventional system and authentication is performed each time a session is established or a service is started between devices, overhead of authentication becomes larger.

For example, the technique disclosed in the above-mentioned Patent Document 1 realizes a group communication system having an authentication function. According to this technique, the group communication system comprises, in addition to devices constituting a group, a relay unit and a group encryption key management unit that has a function of generating a group encryption key and a function of managing information on the terminals belonging to the group. This assumes a large scale network configuration.

Further, according to the technique disclosed in the above-mentioned Patent Document 2, each device participating in group communication should be provided with an IC card. And, it is necessary that the IC card records a group key generation program and a plurality of master keys that have been set in advance for respective groups to which communication partners belong.

Thus, according to the conventional techniques, it is necessary to prepare a device that becomes a certificate server in addition to devices that actually participates in communication, or to prepare storage media that previously store complex information such as relations between master keys and communication partners. Such storage media should be prepared as many as the number of the devices constituting a group.

The present invention has been made taking these circumstances into consideration. And, an object of the invention is to form a group in which devices permitted by a user can easily authenticate one another and to realize safe communication between devices belonging to the group.

Further, another object of the invention is to realize access control under which, when some device outside a group is authorized to access an application provided by a device in the group, that external device is permitted to access that application only.

According to the present invention, a group is formed from devices that authenticate one another by cipher communication using a common key, to perform communication, the security of which is ensured. Each device that can become a member of a group has group management means for generating a group, participating or joining in a group and withdrawing from or leave a group.

Further, a device belonging to some of the groups has also a possibility of communication with another device outside the group.

In detail, the present invention provides a network device that communicates with other network devices connected through a network, wherein: the network device comprising: a group management means, which manages a group consisting of network devices that can authenticate one another; a cipher communication means, which performs cipher communication with the network devices belonging to the group, using a common encryption key; a storage means, which stores cipher communication information required for cipher communication with the network devices belonging to the network, with the information including host names and addresses of the network devices belonging to the group and information of the encryption key; and an acquisition means (a query means), which acquires information from outside; and, when the acquisition means acquires the cipher communication information in a state that the storing means does not store the cipher communication information, the group management means stores the cipher communication information in the storing means and sends identification information of its own network device to the network devices belonging to the group; and, when the group management means acquires identification information of another network device from the another network device through the cipher communication means, the group management means adds said identification information to the cipher communication information stored in the storage means.

Further, the present invention provides a network device that is characterized further in that, when the acquisition means receives an instruction to withdraw from the group, the group management means notifies withdrawal of its own network device to all the network devices belonging to the group through said cipher communication means, and deletes the cipher communication information from said storing means; and when a notification of withdrawal of another network device is received from the another network device through the cipher communication means, the group management means deletes identification information of the another network device from the cipher communication information stored in the storing means.

### BRIEF DESCRIPTION OF DRAWINGS

FIG. 1 is a diagram showing a system configuration of an embodiment according to the present invention;

FIG. 2 is a diagram showing a hardware configuration of a node of the embodiment;

FIG. 3 is a diagram showing a software configuration for a node of the embodiment;

FIG. 4 is a diagram showing a configuration of an IP packet added with an AH header used for group communication;

FIG. 5 is a diagram showing a configuration of an IP packet added with an ESP header used for group communication;

FIG. 6 is a diagram showing a functional configuration of a group management processing unit of the embodiment;

FIG. 7 is a diagram showing a configuration of a data part of a group control IP packet in the embodiment;

FIG. 8 is a diagram showing an example of a configuration of a group management table;

FIG. 9 is a diagram showing an example of a configuration of an access control object application management table;

FIG. 10 is a diagram showing an example of a configuration of a group member management table;

FIG. 11 is a diagram showing an example of a configuration of information set as a security association;

FIG. 12 is a chart showing a procedure of group management processing;

FIG. 13 is a chart showing a procedure of group generation processing;

FIG. 14 is a chart showing a procedure of group participation processing;

FIG. 15 is a chart showing a procedure of new group member notification processing;

FIG. 16 is a chart showing a procedure of group withdrawal processing;

FIG. 17 is a chart showing a procedure of group control IP packet reception processing;

FIG. 18 is a chart showing a procedure in an IP receiving unit at receiving IP packets; and

FIG. 19 is a chart showing a procedure in a received access control unit at receiving IP packets.

### BEST MODE FOR CARRYING OUT THE INVENTION

Now, an embodiment of the present invention will be described referring to the drawings.

The present embodiment will be described taking an example where the present invention is applied to a network comprising home appliances and the like in a home.

A home network of the present embodiment is constructed based on IPv6, and connected with home electric appliances such as a microwave oven and air conditioners, audiovisual equipment such as a television set and a video recorder, sensors, and the like, each being given an IP address. In the following, each device given an IP address of IPv6 is called a node.

In the present embodiment, among these nodes, nodes that a user permits to communicate with one another form a group, and nodes belonging to the group authenticate each other by cipher communication using a common encryption key.

The present network employs IPv6, which can ensure an enormous number of IP addresses as described above. In addition, IPv6 is provided with a cipher and authentication mechanism called IPsec as its standard mechanism. Thus, IPv6 is characterized by a high degree of safety as well as good utility. In the present embodiment, use of IPsec of IPv6 realizes safe communication limited to devices that belongs to a group.

Before describing the present embodiment in detail, an outline of IPsec will be described first.

IPsec is a technique of providing high quality cipher-based security, enabling interconnection in the IP layer. This security is realized by two traffic security protocols, i.e., AH (Authentication Header) and IP encrypted payload ESP (Encapsulation Security Payload).

AH provides a function of preventing falsification of IP packets. And, ESP encrypts an IP packet and stores its authentication data, thus ensuring confidentiality and integrity of the IP packet.

Both AH and ESP use an authentication key and encryption key to generate authentication information and encrypted data, respectively, and authenticate a device as a communication partner based on whether the device has keys to decode the sent data encrypted.

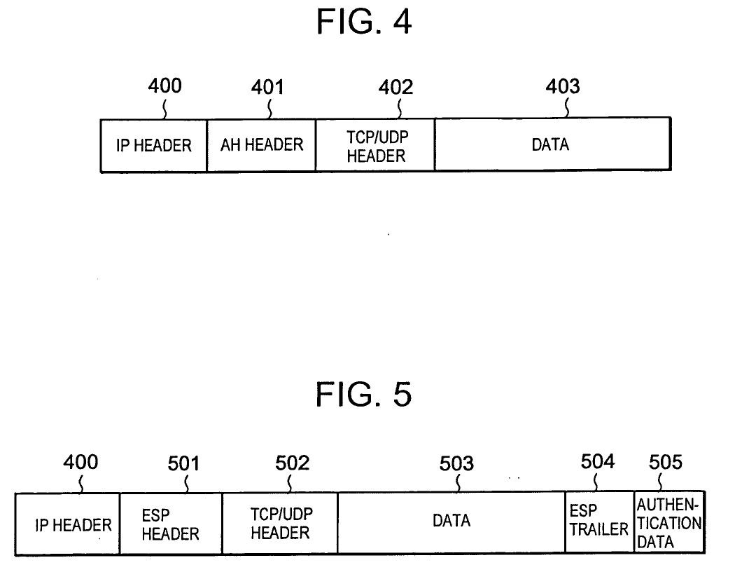

FIGS. 4 and 5 show IP packet configurations in the cases where the AH protocol and the ESP protocols are used, respectively. These packet configurations are IPsec packets prescribed in RFC 2401-2403.

FIG. 4 shows an IP packet configuration in the case where the AH protocol is used. The IP packet in this case comprises an IP header 400, a TCP/UDP header 402, and an AH header 401 for storing a hash value for data 403. Here, TCP means Transmission Control Protocol and UDP means User Datagram Protocol.

The hash value stored in the AH header 401 is used for certifying that the packet has not been falsified, and a value calculated using an authentication key that is held by both of the communicating devices is stored as the hash value. This assumes that both of the devices authenticating each other have the same authentication key. A sender calculates and stores a hash value of data using an authentication key that the sender itself holds, and a receiver compares the received hash value with a hash value calculated by the receiver using an authentication key that the receiver itself holds. When both hash values coincide, the receiver can confirm that the communication partner has the same authentication key. Namely, it is certified that the sender of the packet is a device of a group having the same encryption key.

FIG. 5 shows a configuration of an IP packet in the case of using the ESP protocol. In this header configuration, a TCP/UDP header and data are encrypted.

An IP packet in this case comprises an ESP header 501 for indicating that the packet is an encrypted one, an ESP trailer 504 for delimiting encryption, and authentication data 505. The authentication data 505 is optional and stores a hash value of an ESP header 501, the encrypted TCP/UDP header 502, the data 503 and the ESP trailer 504.

The hash value stored in the authentication data 505 ensures integrity of the IP payload, and ensures confidentiality of the TCP/UDP header 502 and data 503 that are encrypted and transmitted. For encryption, a sender uses an encryption key that the sender itself holds. A receiver uses an encryption key that the receiver itself holds, to decode data that has been encrypted by the sender using the encryption key held by the sender. When the receiver can decode the data, it is confirmed that the communication partner has the same encryption key. In other words, it is certified that the sender of the packet is a device of a group holding the same encryption key.

Further, information such as encryption/authentication algorithm, keys and the like used in IPsec and shared among devices for communicating in accordance with the IPsec standard (hereinafter, a communication performed under the Ipsec standard is called IPsec communication) is managed as a security association (SA).

SA is one-way “connection” for providing security service to traffic transmitted through the connection. Thus, at the time of IPsec communication, SA should be set in advance for each one-way communication between communicating devices. In other words, to establish two-way communication, SA should be set for each of the sending and receiving directions.

Details of IPsec are prescribed in RFC 2401 “Security Architecture for the Internet Protocol”.

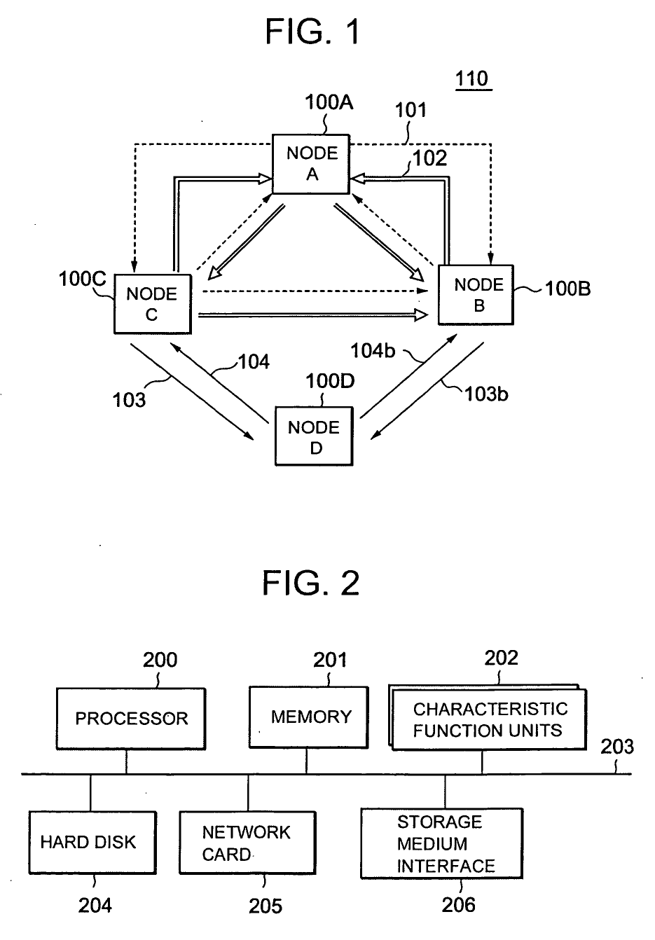

FIG. 1 is a diagram showing a configuration of a group communication system of an embodiment to which the present invention is applied.

As shown in the figure, in the present embodiment, four nodes 100 (100A, 100B, 100C and 100D) are connected to a network 110 according to IPv6. Of course, the number of nodes constituting the network is not limited as such.

Among the nodes 100, commands of the IP packet format are sent and received through the network 110 to realize operation of a service function characteristic to each node 100 by another node 100 and offer of service to another node 100.

Concretely, for example, temperature control of an air conditioner from a television set is realized through the network. Or, it is realized by operation from the television set through the network that an image obtained by a video camera is sent to a video recorder and the video recorder records the image.

For example, it is assumed that the nodes 100A-100C are nodes belonging to a group within which a user permits mutual use of services between nodes, and the node 100D is a node outside the group. Then, between the nodes 100A, 100B and 100C constituting the group, at the time of sending a request for use of a service function, a requesting node sends IP packets that store a hash value calculated by a key (hereinafter, referred to as a group key) shared within the group or encrypted IP packets (the direction 101). On receiving the use request, a requested node uses the group key that it holds, to confirm that the requesting node is a node belonging to the group, and then provides its service to the requesting node (the direction 102). These processes are performed as IPsec communication.

On the other hand, the node 100D uses ordinary IP packets to send its request for using a service function. When the node 100D sends ordinary IP packets to the node 100C (the direction 104), the node 100C judges the node 100D as a node outside the group. Thus, the node 100D receives answer packets rejecting offer of the service (the direction 103).

Here, it is assumed that the node 100B provides a service permitted to a node outside the group. Then, when the node 100D sends ordinary packets designating offer of that service (the direction 104b), the node 100B provides the service (the direction 103b).

Thus, the present embodiment is described taking the example of the network that enables communication using a protocol supporting IPv6 equipped with the IPsec mechanism as its standard mechanism. However, a communication protocol employed is not limited to this, provided that it is possible to construct an environment in which nodes 100 constituting a group have each a common encryption key and communication using the key as an authentication key or an encryption key is possible within the group.

Now, will be described a group management method that realizes safe use of prescribed services between nodes 100 connected to such a network. Namely, will be described a method for generating a group at one node 100, for another node's participating in the generated group, and for withdrawing from the generated group.

In the present embodiment, empty two memory cards A and B are prepared. A node 100 that is the first to participate in a group generates information required for IPsec communication within the group and registers the information into one memory card A. As for nodes 100 that participate in the group thereafter, each node 100 acquires the required information from the memory card A, to participate in the group. At withdrawing from the group, the empty card B is used.

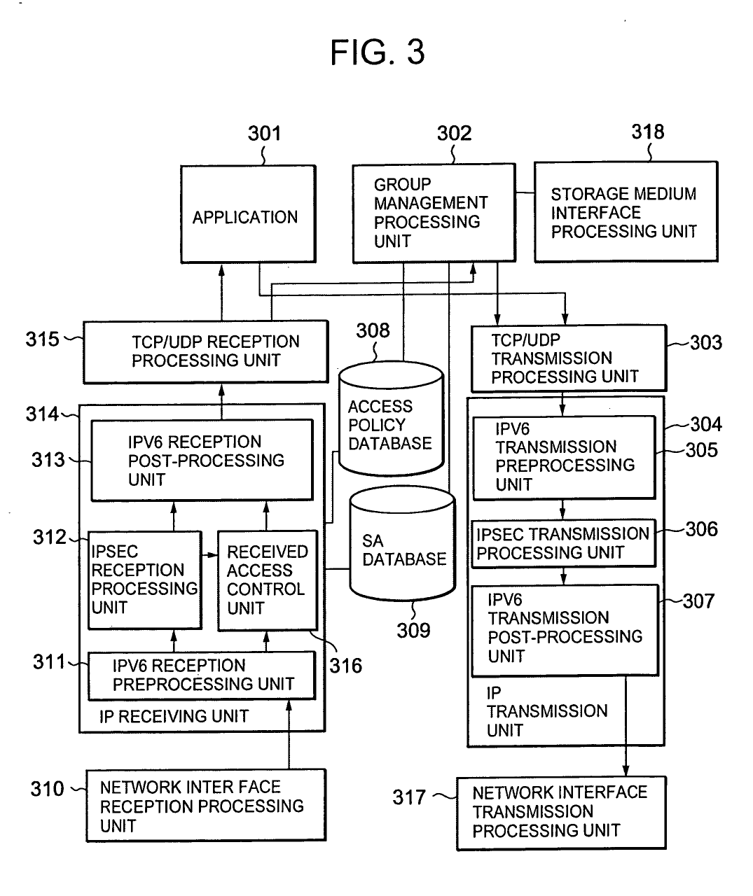

FIG. 2 shows a hardware configuration of a node 100, and FIG. 3 shows a functional configuration of the node 100.

A node 100 comprises: one or more characteristic function units 202 characteristic to the node 100; a network card 205; a processor 200 that controls the characteristic function unit(s) 202 and the network card 205; a memory 201 for storing programs executed by the processor 200; an external storage unit 204 such as a hard disk for storing programs and setting information; a storage medium interface 206 that provides an interface with a memory card or the like for receiving and sending group information; and a system bus 203 that connecting the mentioned components.

For example, in the case of an air conditioner, the characteristic function units 202 for realizing characteristic functions are processing units that control an air conditioning and heating function, a temperature regulation function, and a timer function, for example.

Further, the storage medium interface 206 is provided with an LED (light emitting diode) light for notifying the user that an inserted storage medium is in the course of writing.

Next, functions of each node 100 will be described referring to FIG. 3. Through these functions, each node 100 provides service to another node 100 belonging to the group within which the user permits mutual use of service between nodes 100 through the network.

Each node 100 comprises an application 301, a group management processing unit 302, a TCP/UDP transmission processing unit 303, an IP transmission unit 304, an access policy database 308, an SA database 309, a network interface reception processing unit 310, an IP receiving unit 314, a TCT/UDP reception processing unit 315, a network interface transmission processing unit 317 and a storage medium interface processing unit 318.

The application 301 provides a service characteristic to the node.

The group management processing unit 302 performs management relating to a group, such as generation of a group, withdrawal from a group and update of a group.

The network interface reception processing unit 310 and the network interface transmission processing unit 317 controls the network card 205.

The storage medium interface processing unit 318 controls the storage medium interface 206. When the storage medium interface processing unit 318 detects that a storage medium such as a memory card is inserted into the storage medium interface 206, the storage medium interface processing unit 318 turns on the LED light provided in the storage medium interface 206 to show use of the memory card to the user. Further, when the storage medium interface processing unit 318 receives a notification of the end of processing from the group management processing unit 302, the storage medium interface processing unit 318 turns off the LED light provided in the storage medium interface 206 to notify the user of the end of writing into a storage medium such as a memory card and the end of processing of the group management processing unit 302.

Receiving the notification, the user can take out the memory card from the storage medium interface 206.

The TCP/UDP transmission processing unit 303, the IP transmission unit 304, the IP receiving unit 314 and the TCP/UDP reception processing unit 315 perform processing in respective layers with respect to IP packets to be sent or received, to realize communication.

The IP transmission unit 304 comprises an IPv6 transmission preprocessing unit 305, an IPsec transmission processing unit 306 and an IPv6 transmission post-processing unit 307. The IP receiving unit 314 comprises an IPv6 reception preprocessing unit 311, an IPsec reception processing unit 312 and an IPv6 reception post-processing unit 313. The IP transmission unit 304 and the IP receiving unit 314 realize communication in accordance with IPv6.

Here, the IPv6 reception preprocessing unit 311 performs IPv6 reception preprocessing, which includes confirmation of setting values such as a version, a payload length and a hop limit constituting an IP header and processing of option headers (except for AH and ESP). When an AH header or an ESP header is added to a received IP packet, the IPv6 reception preprocessing unit 311 delivers the IP packet to the IPsec reception processing unit 312. When neither an AH header nor an ESP header is added to a received IP packet, the IPv6 reception preprocessing unit 311 delivers the IP packet to the below-mentioned received access control unit 316.

The IPsec reception processing unit 312 processes AH and ESP among option headers of IP header and judges whether a received IP packet has been sent from a node 100 belonging to the group.

When the IPv6 reception post-processing unit 313 receives an IP packet, the IPv6 reception post-processing unit 313 performs IPv6 reception post-processing such as generation of a pseudo header that includes the sender's IP address and the destination IP address, replacement of the IP header of the received IP packet by the pseudo header, and delivery of the processed IP packet to the TCP/UDP reception processing unit 315. The IP receiving unit 314 further comprises the received access control unit 316.

The received access control unit 316 receives an IP header having neither an AH header nor an ESP header from the IPv6 reception preprocessing unit 311, and controls access of the IP packet to the application.

The SA database 309 stores security associations (SA) required for IPsec.

The access policy database 308 stores information concerning access control for each node and group information, in order to realize communication within the group.

The access policy database 308 has a group management table 600, an access control object application management table 700 and a group member management table 800.

The group management table 600 is also held in the memory card, i.e., a storage medium connected to the node through the storage medium interface 206.

Now, will be described details of the group management processing unit 302, each database of the access policy database 308, and SA in the SA database 309.

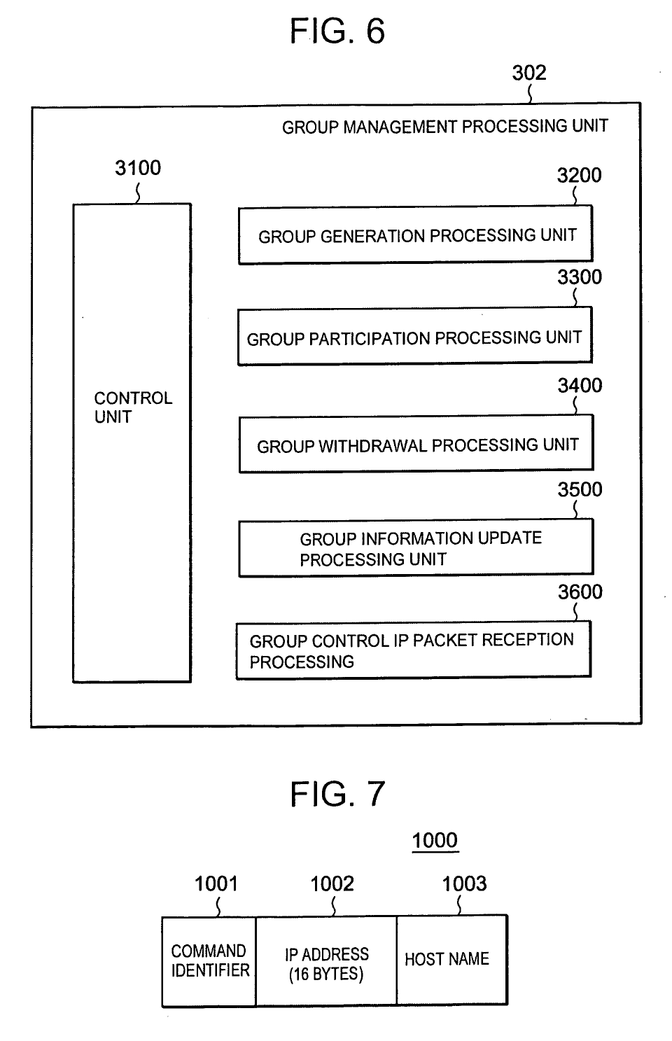

FIG. 6 is a diagram showing a functional configuration of the group management processing unit 302.

As shown in the figure, the group management processing unit 302 comprises a control unit 3100, a group generation processing unit 3200, a group participation processing unit 3300, a group withdrawal processing unit 3400, a group information update processing unit 3500 and a group control IP packet reception processing unit 3600.

The group management processing unit 302 starts its processing when it is instructed from the storage medium interface processing unit 318 that has detected user's insertion of a memory card into the storage medium interface 206.

Receiving an instruction from the storage medium interface processing unit 318, the control unit 3100 searches the inserted memory card and the access policy database 308 of its own node in order to confirm existence of the group management table 600.

The group generation processing unit 3200 performs group generation processing for generating a new group, when a group itself does not exist. The group generation processing is performed when the control unit 3100 judges that the group management table 600 does not exist neither in the memory card nor in the access policy database 308.

Concretely, the group generation processing unit 3200 generates and selects information required for cipher communication with another node that belongs to a group. In other words, the group generation processing unit 3200 generates and selects items to register in a group management table 600, generates the group management table 600, and registers the group management table 600 to the memory card and the access policy database 308.

The group participation processing unit 3300 performs group participation processing in order to let itself participate in an existing group. The group participation processing is performed when the control unit 3100 judges that the group management table 600 exists in the memory card but not in the access policy database 308.

The group participation processing unit 3300 acquires the information required for cipher communication from the inserted memory card. Further, the group participation processing unit 3300 sends information required for cipher communication with its own node 100 to the other nodes 100 that already belong to the group. Concretely, the group participation processing unit 3300 adds its own information to the group management table 600 in the memory card, and registers the group management table 600 added with its own information to the access policy database 308.

Further, the group participation processing unit 3300 generates a group member management table 800 by resolving IP addresses from host names of the nodes 100 that already belong to the group. These host names are obtained from the group management table 600.

Further, the group participation processing unit 3300 sets security associations so as to enable IPsec communication with each node 100 in the group, registers the security associations to the SA database 309, and notifies the nodes of the existing members of the group that its own node has been added to the group, through IPsec communication.

The group withdrawal processing unit 3400 performs group withdrawal processing for withdrawing from a group.

The present embodiment assumes that, when the user desires withdrawal of a certain node 100 from a group, the user inserts the empty memory card into the node 100 in question. In other words, the group withdrawal processing is performed when the control unit 3100 judges that the group management table 600 exists in the access policy database 308 of its own node 100 while the group management table 600 does not exist in the inserted memory card.

In the group withdrawal processing, withdrawal of a node 100 is notified to the other nodes 100 belonging to the group, and the information required for cipher communication within the group is deleted. Namely, the data relating to communication within the group are deleted from the access policy database 308 and SA database 309 of the node 100 to be withdrawn.

Here, when the group participation processing unit 3300 and the group withdrawal processing unit 3400 each notify participation or withdrawal to the other nodes 100 belonging to the group, an IP packet called a group control IP packet having a special data part is used.

Here, a group control IP packet will be described. FIG. 7 shows an example of the data part 1000 of a group control IP packet.

As shown in the figure, the data part 1000 of a group control IP packet includes a command identifier storing part 1001 for storing a command identifier, an IP address storing part 1002 of 16 bytes, and a host name storing part 1003.

In the case of a group control IP packet that is sent to each node 100 belonging to a group for notifying a new participation, the command identifier storing part 1001 is set with (00)ₕₑₓ indicating “entry” (hereinafter, this group control IP packet is referred to as an entry command). And, the IP address storing part 1002 and the host name storing part 1003 are respectively set with its own address and host name.

In the case of a group control IP packet that is sent to each node 100 belonging to a group for withdrawing from the group, the command identifier storing part 1001 is set with (01)ₕₑₓ indicating “withdrawal” (hereinafter, this group control IP packet is referred to as a withdrawal command). And, the IP address storing part 1002 and the host name storing part 1003 are respectively set with its own address and host name.

The group information update processing unit 3500 performs group information update processing for updating the contents of the group management table 600 and copying the updated group management table 600 into the memory card, for example.

In the present embodiment, to improve security, a group key used within a group is updated at predetermined intervals. The group information update processing unit 3500 generates a new group key when a key validity term in the group management table 600 ends.

When a group management table 600 is generated, a key validity term that is different for each node is set. Concretely, a key validity term obtained by adding a random value within a range of −30% to +30% of a predetermined key validity term to that predetermined key validity term is set for each node. As a result, expiration of a key validity term occurs at different timing for each node, and thus one node updates the group key at a time. This prevents simultaneous generation of group keys by members of the group.

A member that has updated the group key encrypts the updated group key using the preceding group key and sends the encrypted group key to each node belonging to the group. At that time, together with the update of the group key, a key validity term of each node may be set again.

Further, when an updated group key is received from another node, the group information update processing unit 3500 updates the group key that its own node holds. At the same time, when an IP address of each node 100 belonging to the group is updated, each IP address in the database concerned is updated.

In the present embodiment, since the group key is updated as described above, the update is not reflected in the group management table 600 in the memory card used for the group participation processing. Similarly, the above-described group withdrawal processing is performed using the empty memory card, and the withdrawing node 100 notifies its withdrawal to the other nodes 100 belonging to the group through IPsec communication. As a result, also a change in the group members is not reflected in the group management table 600 in the memory card used for the group participation processing.

Accordingly, in the present embodiment, the group information update processing unit 3500 updates the group management table 600 in the memory card.

The group information update processing unit 3500 performs processing of updating the group management table 600 in the memory card, when the control unit 3100 judges that the group management table 600 exists both in the access policy database 308 of its own node 100 and in the memory card.

The group information update processing unit 3500 copies the information in the group management table 600 stored in the access policy database 308 of its own node 100 into the group management table 600 in the memory card.

The present embodiment determines such a procedure that, before the group participation processing is actually performed, the memory card is inserted into an existing node 100 of the group to update the group management table 600 in the memory card.

The group control IP packet reception processing unit 3600 performs processing at receiving the above-mentioned group control IP packet.

Concretely, when an entry command is received, the group control IP packet reception processing unit 3600 adds the IP address and the host name stored respectively in the IP address storing part 1002 and the host name storing part 1003 to the group management table 600 and the group member management table 800 of its own node, and generates security associations required for cipher communication with the node 100 that has sent the entry command. On the other hand, when a withdrawal command is received, the group control IP packet reception processing unit 3600 deletes those IP address and host name.

Next, will be described the group management table 600, the access control object application management table 700 and the group member management table 800 stored in the access policy database 308.

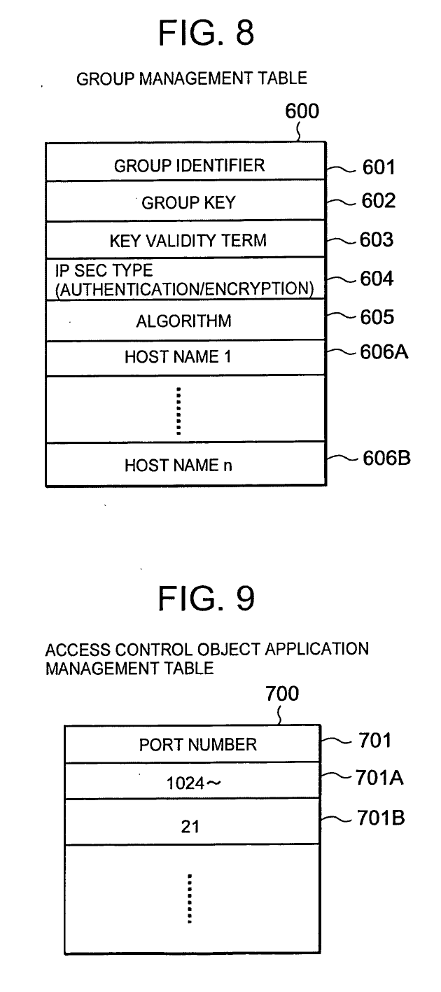

The group management table 600 is a table that stores information for identifying the nodes 100 belonging to the group and information on the key shared by the group. FIG. 8 shows an example of the group management table 600.

As shown in the figure, the group management table 600 has: a group identifier storing field 601 for storing a group identifier used for identifying a group consisting of nodes connected to a network; a group key storing field 602 for storing a group key; a group key validity term storing field 603 for storing a validity term of the group key; an IPsec type storing field 604 for storing a type (such as AH or ESP) of IPsec function used for communication within the group; an algorithm storing field 605 for storing algorithm used for authentication or encryption; and host name storing fields 606 (606A-606B) for storing host names as information for identifying the nodes 100 belonging to the group.

The access control object application management table 700 is a table that stores information used for controlling access to each application installed in the node 100 in the case where an application usable to nodes 100 at the outside of the group is installed in the node 100.

When all the applications installed in the node 100 are ones provided only to accesses from the inside of the group, this table 700 is not necessary.

FIG. 9 shows an example of the access control object application management table 700.

As shown in the figure, the access control object application management table 700 has port number storing fields 701 (701A, 701B) for storing port numbers used by applications opened to nodes 100 outside the group. When an IP packet is received, each node 100 refers to this table 700 to judge whether an application to be accessed by the IP packet is an application opened also to a node 100 outside the group.

Next, will be described the group member management table 800. To start IP packet communication in accordance with IPv6 between nodes 100, an IP address of each node should be known. An IP address of each node 100 belonging to the group is acquired by exchanging ICMP (Internet Control Message Protocol) Echo Request/Reply packets based on a host name of each node 100 in order to resolve an IP address. A host name of each node 100 is acquired at the time of participation in the group. Thus, the group member management table 800 is generated at each node by resolving IP addresses based on the host names, and the group member management table 800 stores a correspondence between a host name and an IP address of each node 100 belonging to the group.

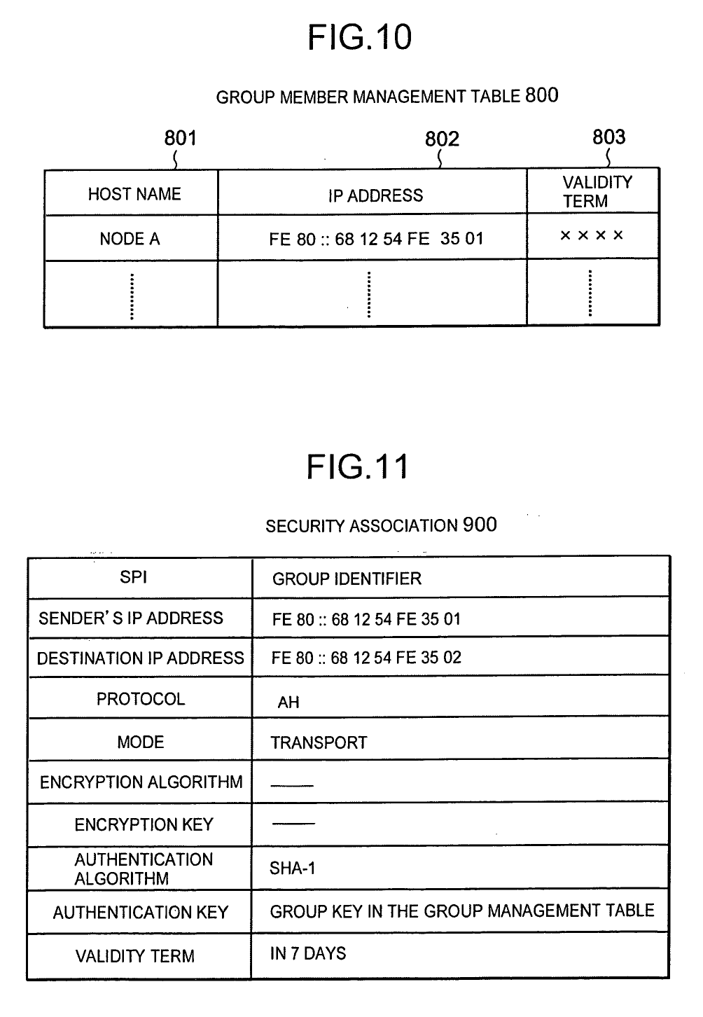

FIG. 10 shows an example of the group member management table 800.

As shown in the figure, the table 800 has a host name storing field 801 for storing a host name identifying a node, an IP address storing field 802 for storing an IP address of the node in association with the host name, and a validity term storing field 803 for storing a validity term of the IP address.

When, for example, a node 100 is restarted, it is possible that an IP address of the node 100 is changed. Further, when neither sending nor receiving is performed in a certain period of time with respect to an IP address stored in the IP address storing field 802, the validity term may expire.

When IP packets are to be sent to such a node, the IPv6 transmission preprocessing unit 305 of the node 100 exchanges ICMP Echo Request/Reply packets to resolve an IP address from the host name again, and notifies the group management processing unit 302 of the IP address. Receiving the notification, the group information update processing unit 3500 of the group management processing unit 302 updates the group member management table 800 that registers IP addresses, and updates the security associations used for communication within the group.

Next, will be described a security association 900 stored in the SA database 309. A security association 900 manages information to be shared for communication in accordance with IPsec. For example, communication is held between the node 100A and the node 100B, a security association 900 is set independently for each of communication in the direction from the node 100A to the node 100B and communication in the direction from the node 100B to the node 10A.

FIG. 11 shows an example of a security association 900.

As shown in the figure, each security association 900 includes an SPI (security policy identifier) for identifying the security association, a sender's IP address, a destination IP address, a protocol for designating authentication or encryption, an encryption range for designating a transport mode or a tunnel mode, an encryption algorithm, an encryption key, an authentication algorithm, an authentication key, a key validity term, and the like.

In the present embodiment, when a security association 900 for sending use is generated at a node 100, the IP address of its own node 100 is set to the sender's IP address and the IP address of the node as the communication partner is set to the destination address. On the other hand, when a security association 900 for receiving use is generated, the IP address of the communication partner is set to the sender's IP address and the IP address of its own node 100 is set to the destination address.

For both sending and receiving uses, the SPI stores the group identifier stored in the group identifier storing field 601 of the group management table 600. Further, for both sending and receiving uses, the protocol, the authentication key algorithm, the authentication key and the validity term respectively store ones stored in the group management table 600.

Hereinabove, various functions and the like of each node 100 of the present embodiment has been described.

Next, will be described a procedure for generating and participating in a group of nodes 100 connected to the network 110, a procedure for withdrawing from a group once participated in, and other procedures.

In the following, as an example, will be described the case where the function type of IPsec is AH, the mode is the transport mode, and the authentication algorithm is SHA-1 (Secure Hash Algorithm—1: prescribed as SHS (Secure Hash Standard) FIPS 180). Of course, the setting of IPsec communication is not limited to this.

Further, as described above, in the present embodiment, two memory cards (i.e., a memory card for storing the group information and an empty card used at withdrawal from a group) are used for generating a group, participating in the group, withdrawing from the group and updating information on the group.

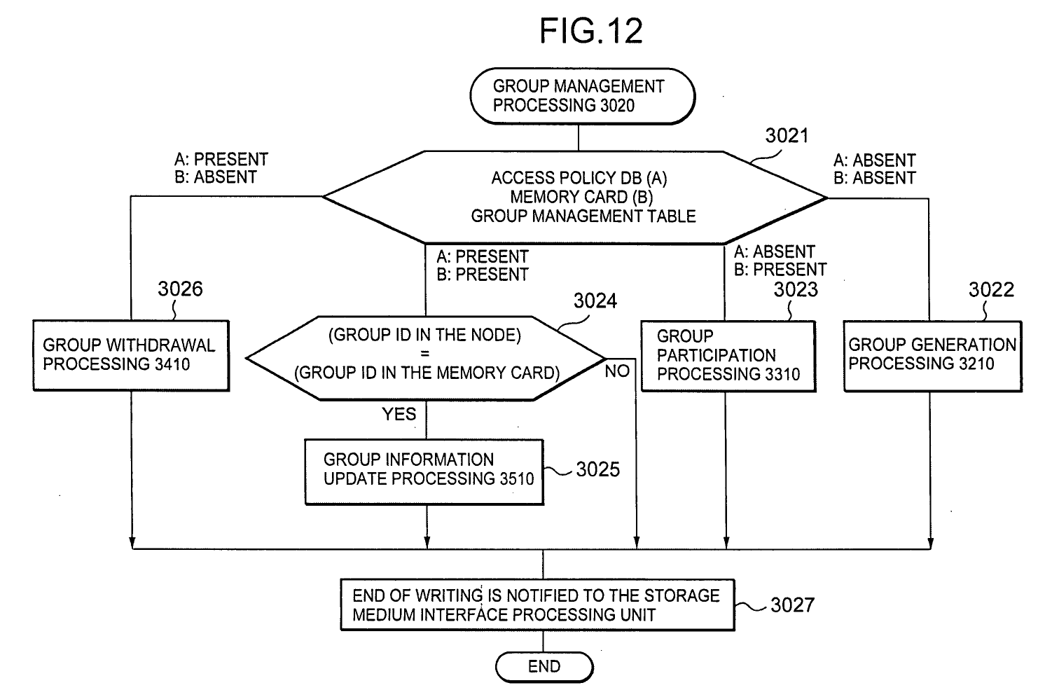

FIG. 12 shows a group management processing procedure 3020, which is performed by the group management processing unit 302.

The group management processing procedure 3020 is started by being triggered by user's insertion of a memory card into the storage medium interface 206 of a node 100.

When the insertion of the memory card into the storage medium interface 206 is detected, the storage medium interface processing unit 318 of the node 100 turns on the LED light provided in the storage medium interface 206 to show use of the memory card to the user.

On the other hand, when the LED light is turned off, the user knows that the processing ends and can take out the memory card.

Further, the storage medium interface processing unit 318 notifies the detection of the memory card to the group management processing unit 302. Receiving the notification, the group management processing unit 320 starts the group management processing procedure 3020.

First, the control unit 3100 of the group management processing unit 302 accesses the access policy database 308 of its own node and the inserted memory card through the storage medium interface processing unit 318, to confirm existence of the group management table 600 (Step 3021).

Here, in the case where the group management table 600 exists neither in the access policy database 308 nor in the memory card, it is judged that a group itself does not exist, i.e., it is necessary to generate a group. Thus, the control unit 3100 makes the group generation processing unit 3200 perform the group generation processing 3210 (Step 3022). When the group generation processing 3210 is finished, the control unit 302 notifies the end of writing into the memory card to the storage medium interface processing unit 318 (Step 3027), and ends the processing.

In the case where the group management table 600 does not exist in the access policy database 302 of its own node but exists in the memory card, the control unit 3100 judges that its own node 100 is going to participate in the group existing in the memory card. Thus, the control unit 3100 makes the group participation processing unit 3300 perform the group participation processing 3310 (Step 3023). When the group participation processing is finished, the control unit 3300 goes to Step 3027.

In the case where the group management table 600 does not exist in the memory card but exists in the access policy database 302 of its own node 100, the control unit 3100 judges that its own node 100 already belongs to a group but is going to withdraw from the group since the empty card has been inserted. Thus, the control unit 3100 makes the group withdrawal processing unit 3400 perform the group withdrawal processing 3410 (Step 3026). When the group withdrawal processing is finished, the control unit 3300 goes to Step 3027.

In the case where the group management table 600 exists both in the access policy database 308 and in the memory card, the control unit 3100 first compares the group identifier in the group management table 600 of the access policy database 302 and the group identifier in the group management table 600 of the memory card (Step 3024).

When both group identifiers coincide, the control unit 3100 judges that the group information in the memory card should be updated. Thus, the control unit 3100 makes the group information update processing unit 3500 perform the group information update processing 3510, i.e., copying of the group management table 600 in the access policy database 302 into the memory card (Step 3025). When the processing is finished, the control unit 3100 goes to Step 3027.

When both group identifiers are different from each other in Step 3024, the control unit 3100 judges that an incorrect memory card has been inserted, and simply goes to Step 3027.

Next, will be described the group generation processing 3210, the group participation processing 3310, the group withdrawal processing 3410, and the group information update processing 3510.

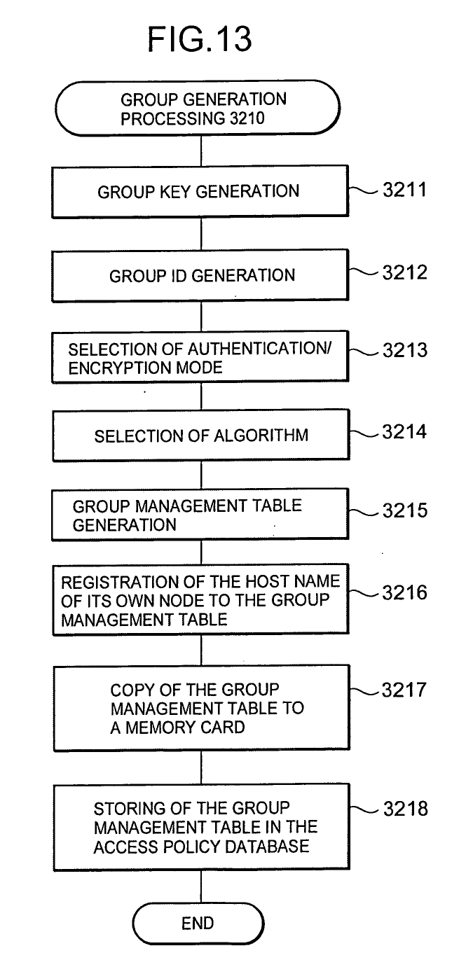

First, FIG. 13 shows a procedure of the group generation processing 3210.

Receiving an instruction from the control unit 3100 to start the processing, the group generation processing unit 3200 generates a group key (Step 3211), generates a group identifier for identifying a group to be generated (Step 3212), selects “authentication” (AH) as the authentication/encryption mode (Step 3213), and selects SHA-1 as the algorithm (Step 3214).

Then, the group generation processing unit 3200 stores these pieces of information respectively into the group key storing field 602, the group identifier storing field 601, the IPsec type storing field 604 and the algorithm storing field 605, to generate a group management table 600 (Step 3215). Then, the group generation processing unit 3200 registers the host name of its own node 100 into the host name storing field 606 (Step 3216).

When the group management table 600 is finished, the group generation processing unit 3200 copies the table 600 to the memory card, and stores the table 600 in the access policy database 308 of its own node 100 (Steps 3217 and 3218), and notifies the end of the processing to the control unit 3100.

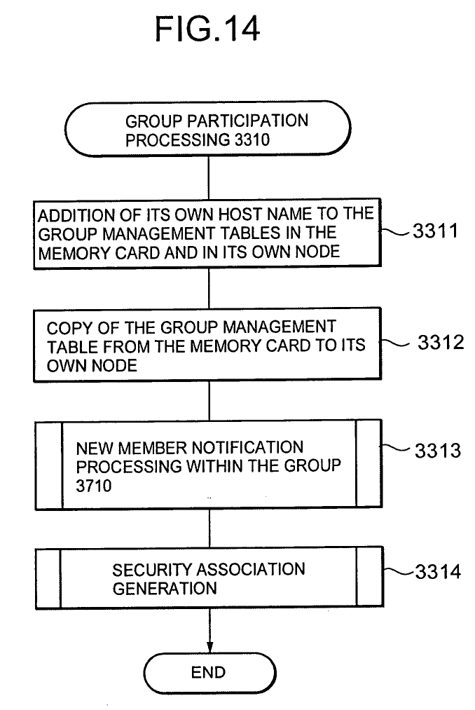

Next, FIG. 14 shows a procedure of the group participation processing 3310.

When an instruction is received from the control unit 3100 to start the processing, the group participation processing unit 3300 adds the host name of its own node to the host name storing fields 606 of the group management table 600 in the memory card (Step 3311), and stores the group management table 600 in the memory card into the access policy database 308 of its own node (Step 3312).

Next, the group participation processing unit 3300 generates a group member management table 800 and performs a new member notification processing 3710 for notifying the participation of its own node to the nodes 100 already belonging to the group (Step 3313).

Then, using the information recorded in the group management table 600 and the group member management table 800 in the above steps, the group participation processing unit 3300 generates security associations used for IPsec communication with each node 100 (Step 3314), and notifies the end of the processing to the control unit 3100.

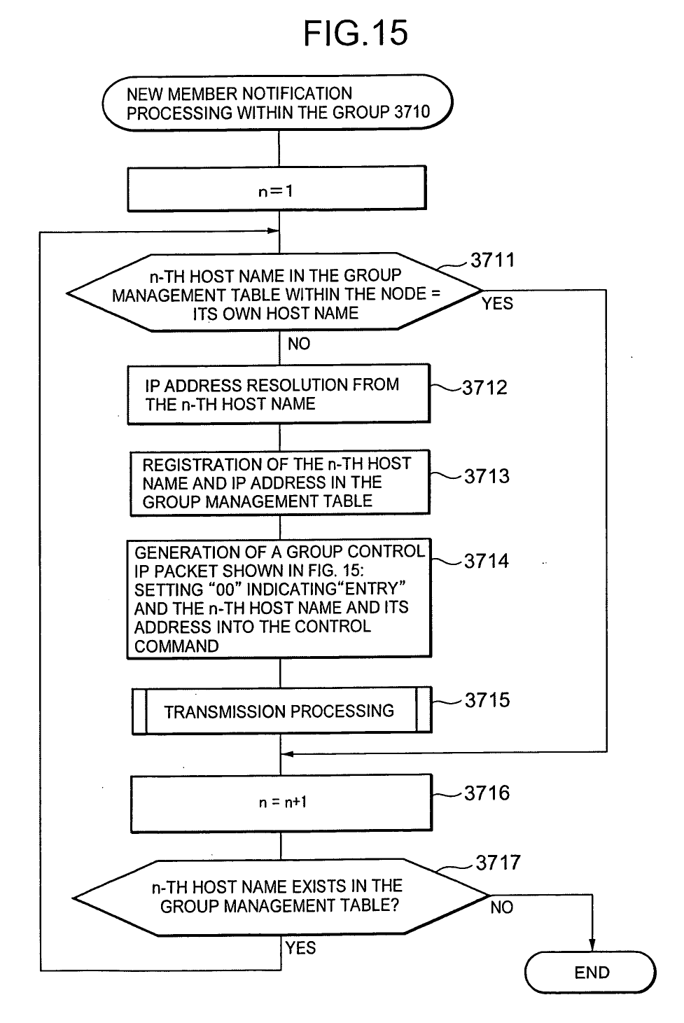

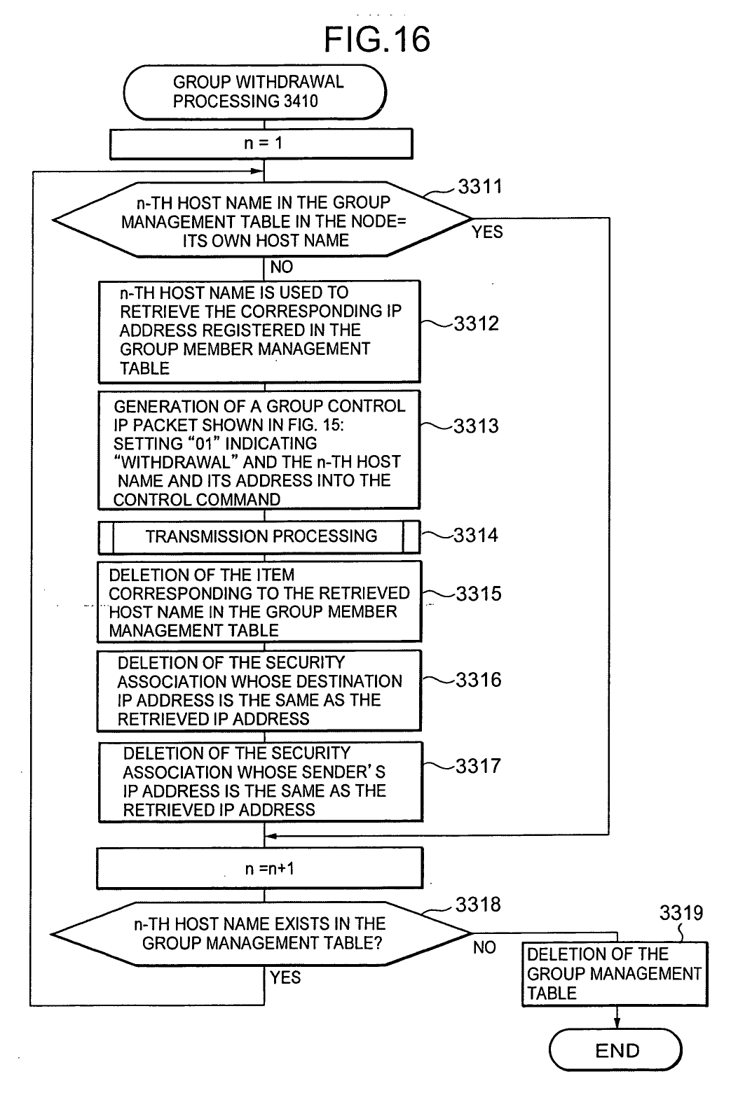

Here, a procedure of the new member notification processing 3710 will be described. FIG. 15 shows the procedure.

In the new member notification processing 3710, an IP address is obtained through ICMP Echo Request/Reply, in an order of each host name stored in the host name storing fields 606 of the group management table 600 (Step 3712), and the obtained IP address for each host name is registered in the group member management table 800 (Step 3713).

An entry command is generated (Step 3714) and transmitted (Step 3715) to an IP address of each node 100 belonging to the group. Here, the IP address is obtained in the above step.

Then, the next host name is read, and the processing is repeated from Step 3711 through Step 3717. Here, when the read host name is the host name of its own node, no processing is performed and the next host name is read (Step 3711).

When the above processing is finished for all the nodes (except its own node 100) whose host names are stored in the host name storing fields 606 of the group management table 600 (Step 3717), the new group member notification processing 3710 is ended.

Hereinabove, the group participation processing 3310 has been described.

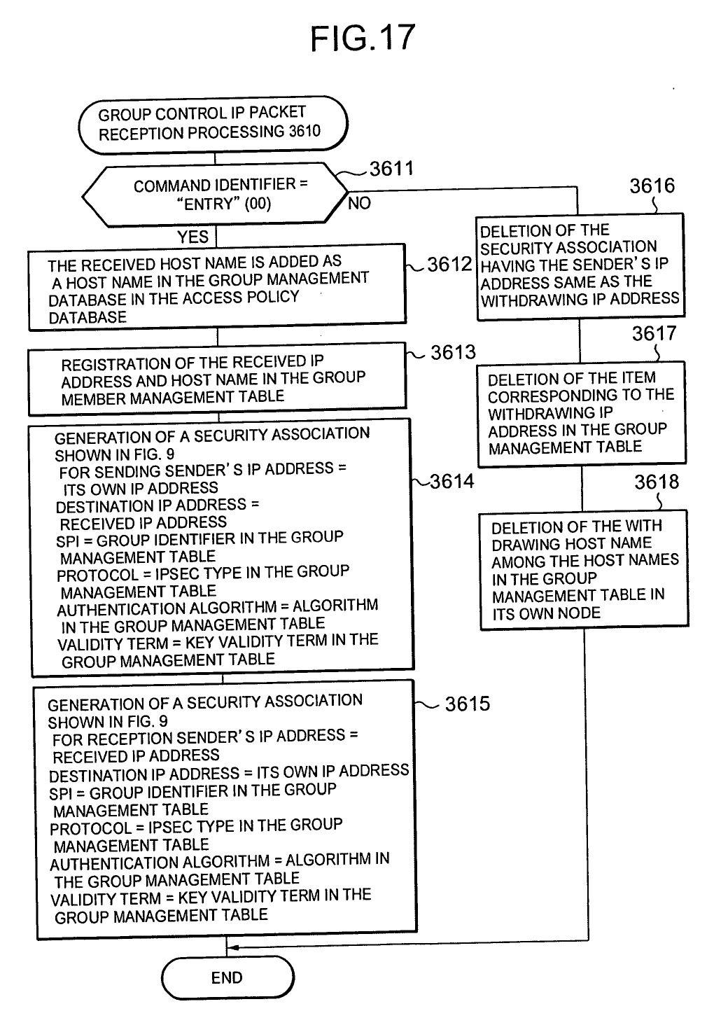

Next, will be described the group withdrawal processing 3410 will be described referring to FIG. 16.

When an instruction is received from the control unit 3100 to start the processing, the group withdrawal processing unit 3400 reads, in an order of a host name registered in the host name storing field 606 of the group management table 600 in its own node 100 (Step 3311).

Here, in the case where the read host name coincides with its own host name, the next host name is read.

In the case where the read host name does not coincide with its own host name, an IP address corresponding to the read host name is retrieved from the group member management table 800 (Step 3312). Hereinafter, this IP address is referred to as the retrieved IP address.

Next, a withdrawal command having the retrieved IP address as its destination IP address is generated (Step 3313) and sent to the node 100 having that destination IP address (Step 3314).

The group withdrawal processing unit 3400 deletes data concerning the retrieved IP address (for which the above operation has been performed) from the group member management table 800 held by its own node (Step 3315).

Next, among the security associations 900 stored in the SA database 309, a security association having the destination IP address that is the same as the retrieved IP address is extracted, and the extracted security association 900 is deleted (Step 3316).

Further, a security association 900 having the sender's IP address that is the same as the retrieved IP address is extracted, and the extracted security association is deleted (Step 3317).

After the group withdrawal processing unit 3400 performs the processing from the above Step 3311 through Step 3317 for all the host names registered in the group management table 600 (Step 3318), the group withdrawal processing unit 3400 deletes the group management table 600 held by its own node (Step 3319), to end the group withdrawal processing 3410. Then, the end of the processing is notified to the control unit 3100.

Next, will be described processing performed on the side of each node 100 at the time of receiving the entry command or the withdrawal command sent in Step 3715 of the new group member notification processing 3710 in the group participation processing 3310 or in Step 3314 of the group withdrawal processing 3310.

This processing is performed by the group control IP packet reception processing unit 3600, and is referred to as group control IP packet reception processing 3610. FIG. 17 shows a procedure of this processing.

When the network interface reception processing unit 310 of each node 100 belonging to the group receives the group control IP packet, the network interface reception processing unit 310 delivers the received group control IP packet to the group control IP packet reception processing unit 3600 of the group management processing unit 302 through the IP receiving unit 314 and the TCP/UDP reception processing unit 315.

Receiving the group control IP packet, the group control IP packet reception processing unit 3600 judges whether the command identifier set in the command identifier storing part 1001 is “entry” or not (Step 3611).

When it is judged in Step 3611 that the command identifier is (00)ₕₑₓ indicating “entry” (i.e., an entry command is received), the processing goes to Step 3612 to register the host name set in the host name storing part 1003 of the group control IP packet to the group management table 600 (Step 3612). This host name is the host name of the node 100 that has sent the entry command (Step 3612).

Then, the group control IP packet reception processing unit 3600 registers the host name of the node 100 that has sent the entry command and its IP address set in the IP address storing part 1002 of the group control IP packet to the group member management table 800 (Step 3613).

Next, the group control IP packet reception processing unit 3600 performs processing of generating security associations 900 for sending and receiving uses respectively. Here, the security association 900 for sending use is used for transmission from its own node 100 to the node 100 that has sent the entry command to participate in the group anew. And, the security association 900 for receiving use is used for transmission from the node 100 that has sent the entry command to participate in the group anew to its own node 100 (Steps 3614 and 3615).

Next, when it is judged in Step 3611 that the command identifier is (01)ₕₑₓ indicating “withdrawal” (i.e., a withdrawal command is received), the group control IP packet reception processing unit 3600 goes to Step 3616.

Here, the group control IP packet reception processing unit 3600 extracts a security association 900 having the destination IP address that is the same as the IP address stored in the IP address storing part 1002 of the data part 1000 of the received group withdrawal command, among the security associations 900 stored in the SA database 309. Then, the group control IP packet reception processing unit 3600 deletes the extracted security association (Step 3616).

Next, the group control IP packet reception processing unit 3600 deletes data having the IP address that is the same as the IP address 1002 of the received withdrawal command from the group member management table 800 (Step 3617), and deletes the host name that is the same as the host name stored in the host name storing part 1003 of the received withdrawal command from the group management table 600 of its own node 100 (Step 3618).

When the above procedure is performed in all the nodes 100 in the group, the security associations 900 corresponding to the withdrawn node 100, which are held by those nodes 100, are deleted, and the information on the withdrawn node 100 is deleted from the group management tables 600 in all the nodes 100.

Thus, when there is a change such as a new entry or a withdrawal in the nodes 100 constituting the group, the nodes 100 that receive a group control IP packet sent from the node 100 in question update the security associations and group management tables 600 held by them.

The group control IP packet reception processing has been thus described.

Hereinabove, the group management processing (such as generation of a group, participation in a group and withdrawal from a group) performed in the group management processing unit 302 has been described.

Next, will be described a procedure for using an application from one another within a group that is generated and managed according to the above-described procedures.

An application is used by sending and receiving IP packets from one another. First, sending and receiving of IP packets will be described.

As described above, security associations 900 that should be set prior to IPsec communication are generated in the group management processing when a new group member is added. In other words, a member can have IPsec communication as far as that member belongs to the group.

At the time of sending IP packets, the IPsec transmission processing unit 306 searches the SA database 309 using the destination address of the IP header to be sent as a search key, to extract a security association 900 that stores the same IP address as the destination IP address. Then, based on the information registered in the extracted security association 900, the IPsec transmission processing and the IPv6 transmission post-processing 307 are performed to send the IP packets to the destination node through the network interface transmission processing unit.

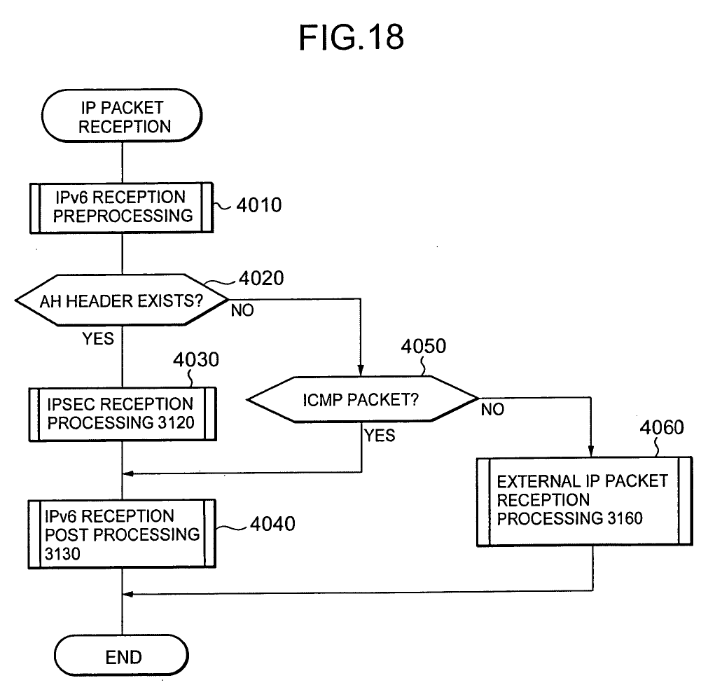

Next, a procedure performed at the time of receiving an IP packet will be described referring to FIG. 18.

When an IP packet is received through the network interface reception processing unit 310, the IPv6 reception preprocessing unit 311 performs the IPv6 reception preprocessing (Step 4010) and examines whether an AH header exists in the received IP header (Step 4020).

When it is judged that an AH header 401 exists in the received IP header, the IPv6 reception preprocessing unit 311 delivers the IP packet to the IPsec reception processing unit 312.

Receiving the IP packet, the IPsec reception processing unit 312 performs the below-mentioned IPsec reception processing 3120 (Step 4030), and delivers the IP packet to the IPv6 reception post-processing unit 313.

The IPv6 reception post-processing unit 313 performs the IPv6 reception post-processing 3130 (Step 4040) and ends the processing.

Here, when the IPv6 reception post-processing 3130 on the received IP packet is finished, the IPv6 reception post-processing unit 313 delivers the IP packet to the TCP/UDP reception processing unit 315. Receiving the IP packet, the TCP/UDP reception processing unit 315 performs the reception processing on the received IP packet and delivers the IP packet as received data to the application 301.

When it is judged in Step 4020 that an AH header does not exist, the IPv6 reception preprocessing unit 311 delivers the IP packet to the received access control unit 316.

Receiving the IP packet, the received access control unit 316 examines whether the received IP packet is an ICMP packet (Step 4050).

When it is judged in Step 4050 that the received IP packet is an ICMP packet, then the received access control unit 316 simply delivers the IP packet to the IPv6 reception post-processing unit 313 where the IPv6 reception post-processing 3130 is performed (Step 4040) and the processing is ended.

When it is judged in Step 4050 that the received IP packet is not an ICMP packet, then the received access control unit 316 judges that the IP packet is an external IP packet sent from a node 100 outside the group, and performs the below-mentioned external IP packet reception processing 3160 (Step 4060) and the processing is ended.

Next, will be described the above-mentioned IPsec processing 3120.

When an IP packet having an AH header is received, the IPsec processing unit 312 extracts a security association 900 whose sender's IP address, destination IP address and SPI coincide with the sender's IP address and the destination IP address in the IP header and the SPI set in the AH header 401 of the IP packet, from the SA database 309.

Then, using the authentication key stored in the extracted security association 900, the IPsec processing unit 312 generates authentication information of the received IP packet and compares the generated authentication information with the authentication information set in the AH header 401.

When both pieces of authentication information coincide, the IPsec processing unit 312 judges that the received IP packet has been sent from an authorized node 100 belonging to the group, and delivers the IP packet to the IPv6 reception post-processing unit 313. When both pieces of authentication information do not coincide, the IPsec processing unit 312 discards the IP packet.

Hereinabove, the IPsec processing 3120 has been described.

Next, will be described the external IP packet reception processing 3160 performed by the received access control unit 316.

As described above, in the present embodiment, when a node 100 belonging to the group receives an IP packet having an AH header is received from a node 100 outside the group, then the IPsec reception processing unit 312 (in the case of the IP packet having an AH header) or the IPv6 reception preprocessing unit 311 (in the case of the IP packet without an AH header) prevents the IP packet from reaching the application 301 through the IPv6 reception post-processing unit 313 and the TCP/UDP reception processing unit 315.

However, in the present embodiment, some nodes 100 open their applications for use by other nodes 100 outside the group. As described above, a node 100 having such an application uses the access control object application management table 700 to manage respective port numbers of its applications.

When an IP packet having an AH header is received from a node 100 outside the group, that IP packet can not be decoded and the IPsec reception processing unit 312 discards the IP packet, as described above.

The external IP packet reception processing 3160 is a processing for delivering an IP packet received from a node 100 outside the group to an application opened to such a node 100 outside the group if the received IP packet is an ordinary IP packet.

In the external IP packet reception processing 3160, when a node 100 that has received the IP packet in question provides no service function to nodes outside 100 the group, the node sends an IP packet that stores “access error” as the data to the sender of the received IP packet and discards the received IP packet. On the other hand, when a node 100 that has received the IP packet in question provides some service function to nodes 100 outside the group, control is performed to provide the application in accordance with the registration of the access control object application management table 700.

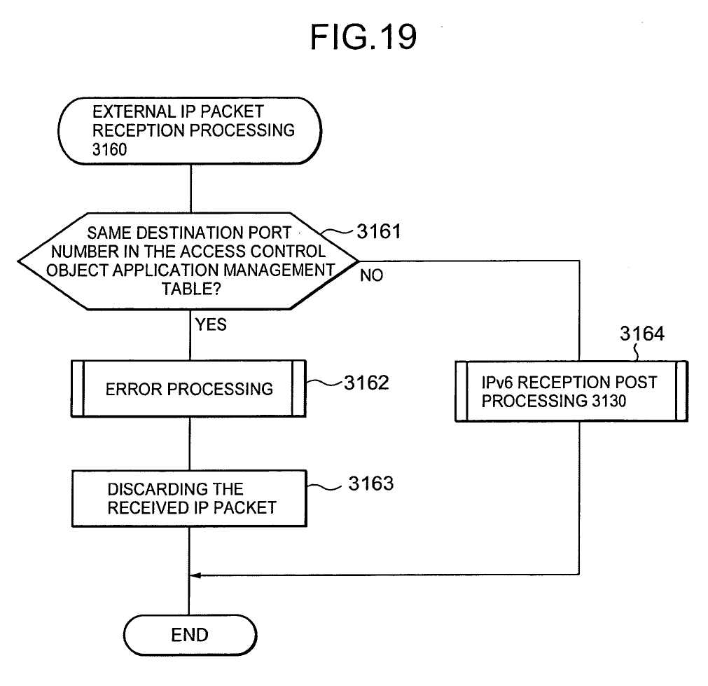

Now, this procedure will be described referring to FIG. 19.

When an IP packet that is not an ICMP packet is received from the IPv6 reception preprocessing unit 311, the received access control unit 316 compares the destination port number read from the IP packet with the port numbers 701 registered in the access control object application management table 700 (Step 3161).

The access control object application management table 700 registers port numbers of applications whose use is permitted to nodes outside the group. Thus, when there is a port number coincident with the destination port number read from the IP packet, it is possible to provide the service function to the node 100 requesting that service function.

In this case, the received access control unit 316 delivers the received IP packet to the IPv6 reception post-processing unit 313. Receiving the IP packet, the IPv6 reception post-processing unit 313 performs the IPv6 reception post-processing 3130 (Step 3164).

Then, the TCP/UDP reception processing unit 315 receives the processed IP packet from the IPv6 reception post-processing unit 313, and delivers the IP packet to the application 301.

In the case where there is no port number coincident with the destination port number read from the IP packet in Step 3161, there is no service function that can be provided. Accordingly, the received access control unit 316 generates an IP packet that stores “access error” as the data and sends the generated IP packet to the sender of the received IP packet through the IP transmission unit 304 (Step 3162), and discards the received IP packet (Step 3163).

Hereinabove, the external IP packet reception processing has been described.

Thus, in the present embodiment, IPsec communication is employed between nodes 100 within the group, while ordinary IP packets are used for communication with a node 100 outside the group. As a result, permission of accesses from the inside and outside of the group can be controlled with respect to each application, in accordance with a port number of each application managed in the access control object application management table 700. Accordingly, it is possible to install service functions usable within the group and service functions usable to anyone into one node 100, and to control access to each service function.

According to the present embodiment, information required for IPsec communication includes a group key generated by a node 100 belonging to a home network. The mentioned information is distributed by means of a common memory card to nodes 100 whose mutual use is permitted by each user.

When the information is distributed to a node 100, the node 100 sets security associations 900 to enable IPsec communication with the other nodes 100 belonging to the group, and sends a notification of its new entry to the group to the other nodes 100 belonging to the group.

Receiving the notification, each node 100 sets security associations 900 to enable IPsec communication with the new node 100.

As described above, according to the present embodiment, members within a group can safely start communication with one another while authenticating one another without through a device that is not a member of the group, such as for example, a certificate server or a device provided with a key management means. A device can easily generate and manage such a group of which the device itself is a member.

Further, according to the present embodiment, information required for generating and managing a group is given to each node by means of a storage medium such as a memory card, and instructions relating to generation of a group, participation in the group and withdrawal from the group are given to each node by means of the storage medium.

Thus, according to the present invention, it is possible to construct an environment that enables IPsec communication only between devices constituting a group, without providing a special device such as a server and without making prior preparations such as preparation of IC cards containing a plurality of master keys or the like and previous setting of those IC cards respectively into devices constituting the group.

Further, in the present embodiment, even when an application usable only for nodes within a group and an application usable also for nodes outside the group are both installed in one node, it is easy to realize access control of each application.

The present embodiment has been described taking a memory card as an example of the storage medium used for generating, participating in and withdrawing from a group. However, the storage medium is not limited to a memory card. Any storage medium can be used as far as each node has an interface with it.

Further, the present embodiment is arranged such that the information required for IPsec communication is sent and received through a storage medium. However, sending and receiving of the information is not limited to this. For example, each node may be provided with an input unit through which a user inputs the information.

Further, the present embodiment has been described taking the example in which the group withdrawal processing is started being triggered by insertion of the empty memory card. However, starting of the withdrawal processing is not limited to this. For example, each node may be provided with a reset button, and a user gives an instruction to start the withdrawal processing through the reset button.

Further, the present embodiment is provided with an LED light to notify a user of ends of the group generation processing and the participation processing. The function of notification is not limited to this.

The present invention is not limited to the above-described embodiment, and can be varied variously within the scope of the invention.

For example, the above embodiment has been described taking the example of a home network. However, the present invention is not limited to this. The present invention can be applied widely to various network systems in which authentication between members is required.

According to the present embodiment, without providing a special certificate server or a device having key management means, it is possible to authenticate group member devices between those devices and thus it is easy to generate and manage a group that realizes safe communication.

Further, in the case where a device has an application usable for devices within a group and an application usable for devices outside the group, access control of the applications can be performed with simple arrangement.

1. A network device that communicates with other network devices connected through a network, wherein:
said network device comprising:
a group management means, which manages a group consisting of network devices that can authenticate one another;
a cipher communication means, which performs cipher communication with the network devices belonging to said group, using a common encryption key;
a storage means, which stores cipher communication information required for cipher communication with the network devices belonging to said network, with said information including information of said encryption key and identification information including host names and addresses of the network devices belonging to said group; and
an acquisition means, which acquires information from outside; and
when said acquisition means acquires said cipher communication information in a state that said storing means does not store said cipher communication information, said group management means stores said cipher communication information in said storing means and sends identification information of its own network device to the network devices belonging to said group; and
when said group management means acquires identification information of another network device from said another network device through said cipher communication means, said group management means adds said identification information to said cipher communication information stored in said storage means.

2. A network device according to claim 1, wherein:
when said acquisition means receives an instruction to withdraw from the group, said group management means notifies withdrawal of its own network device to all the network devices belonging to said group through said cipher communication means, and deletes said cipher communication information from said storing means; and
when a notification of withdrawal of another network device is received from said another network device through said cipher communication means, said group management means deletes identification information of said another network device from said cipher communication information stored in said storing means.

3. A network device according to claim 2, wherein:
said acquisition means is an interface with a storage medium; and
when a storage medium, which stores said cipher communication information, is inserted into said acquisition means in a state that said storage medium stores said cipher communication information, said group management means copies the cipher communication information stored in said storage means to said storage medium.

4. A network device according to claim 3, wherein:
said network device further comprises:
a non-cipher communication means, which performs non-cipher communication; and
an access control means, which controls accesses to services provided by said network device; and
when there occurs an access from another network device through said non-cipher communication means, said access control means permits said access when said access is an access to a predetermined port.

5. A network system comprising a plurality of network devices, and a network that connects said plurality of network devices, wherein:
each of said plurality of network devices is a network device according to claims 4.

6. A group management method for managing a group consisting of devices connected through a network, with a device of the group being able to perform cipher communication with another device of the group while authenticating each other, comprising:
a group generation step, in which one device connected to said network generates an encryption key used for said cipher communication, and holds, as cipher communication information, said encryption key and identification information including a host name and address of said one device itself;
a first group participation step, in which a device that acquires said cipher communication information notifies identification information of the device itself and information indicating participation of the device itself to all devices whose identification information is stored in said cipher communication information, and said device adds said identification information of the device itself to said cipher communication information and holds said cipher communication information;
a second group participation step, in which a device that receives said identification information and said information indicating the participation adds said identification information to the cipher communication information that said device holds;
a first withdrawal step, in which a device that receives an instruction to withdraw from said group notifies information indicating withdrawal and identification information of the device itself to all devices excluding said device itself whose identification information is stored in said cipher communication information, and deletes the cipher communication information that the device itself holds; and
a second withdrawal step, in which a device that receives the notification of said withdrawal deletes the notified identification information from the cipher communication information that the device itself holds.

7. A program that makes a computer function as:
a group generation means that generates an encryption key used for cipher communication and holds, as cipher communication information, said encryption key and identification including a host name and address of the computer itself;
a first group participation means that notifies identification information and information indicating participation of the computer itself to all devices whose identification information is stored in said cipher communication information, through cipher communication, and adds the identification information of the computer itself to said cipher communication information, when said cipher communication information is acquired;
a second group participation means that adds said identification information of another device to the cipher communication information that the computer itself holds, when said identification information of said another device and information indicating participation of said another device are received from said another device;
a first group withdrawal means that notifies information indicating withdrawal and identification information of the computer-itself to all devices excluding the computer itself whose identification information is stored in the cipher communication, through the cipher communication, and deletes said cipher communication information that the computer itself holds, when an instruction to delete the cipher communication information is received; and
a second group withdrawal means that deletes identification information of another device from the cipher communication information that the computer itself holds, when said identification information of said another device and information indicating withdrawal of said another device are received.

8. A network device according to claim 1, wherein:
said acquisition means is an interface with a storage medium; and
when a storage medium, which stores said cipher communication information, is inserted into said acquisition means in a state that said storage medium stores said cipher communication information, said group management means copies the cipher communication information stored in said storage means to said storage medium.

9. A network device according to claim 8, wherein:
said network device further comprises:
a non-cipher communication means, which performs non-cipher communication; and
an access control means, which controls accesses to services provided by said network device; and
when there occurs an access from another network device through said non-cipher communication means, said access control means permits said access when said access is an access to a predetermined port.

10. A network device according to claim 1, wherein:
said network device further comprises:
a non-cipher communication means, which performs non-cipher communication; and
an access control means, which controls accesses to services provided by said network device; and
when there occurs an access from another network device through said non-cipher communication means, said access control means permits said access when said access is an access to a predetermined port.

11. A network device according to claim 2, wherein:
said network device further comprises:
a non-cipher communication means, which performs non-cipher communication; and
an access control means, which controls accesses to services provided by said network device; and
when there occurs an access from another network device through said non-cipher communication means, said access control means permits said access when said access is an access to a predetermined port.

12. A network system comprising a plurality of network devices, and a network that connects said plurality of network devices, wherein:
each of said plurality of network devices is a network device according to claim 11.

13. A network system comprising a plurality of network devices, and a network that connects said plurality of network devices, wherein:
each of said plurality of network devices is a network device according to claim 10.

14. A network system comprising a plurality of network devices, and a network that connects said plurality of network devices, wherein:
each of said plurality of network devices is a network device according to claim 9.

15. A network system comprising a plurality of network devices, and a network that connects said plurality of network devices, wherein:
each of said plurality of network devices is a network device according to claim 8.

16. A network system comprising a plurality of network devices, and a network that connects said plurality of network devices, wherein:
each of said plurality of network devices is a network device according to claim 1.

17. A network system comprising a plurality of network devices, and a network that connects said plurality of network devices, wherein:
each of said plurality of network devices is a network device according to claim 2.

18. A network system comprising a plurality of network devices, and a network that connects said plurality of network devices, wherein:
each of said plurality of network devices is a network device according to claim 3.
